(19) United States
(12) Patent Application Publication
(10) Pub. No.: US 2021/0263442 A1
(43) Pub. Date: Aug. 26, 2021

(54) IMAGE FORMING APPARATUS

(71) Applicant: KYOCERA Document Solutions Inc., Osaka-shi (JP)

(72) Inventors: Tamotsu SHIMIZU, Osaka-shi (JP); Kazunori TANAKA, Osaka-shi (JP); Kanako MORIMOTO, Osaka-shi (JP); Shiro KANEKO, Osaka-shi (JP)

(21) Appl. No.: 17/178,577

(22) Filed: Feb. 18, 2021

(30) Foreign Application Priority Data
Feb. 21, 2020 (JP) 2020-027940

(51) Int. Cl. G03G 15/06; G03G 15/00

(52) U.S. Cl. CPC G03G 15/065; G03G 15/50; G03G 15/80

(57) ABSTRACT

An image forming apparatus includes a plurality of image forming units, a developing voltage power supply, a current detection unit, and a control unit. The image forming units form an image by superimposing a toner image of a same color and a same type, and substantially same development conditions are set to evenly divide an image density among the image forming units. The control unit detects whether there is an anomaly in the image forming unit based on detecting a DC component of developing current, being either of current flowing through a non-exposed portion of an image carrier during image formation, and current flowing through an exposed portion of the image carrier. When an anomaly is detected in any image forming unit, the control unit inhibits use of the image forming unit, and resets the development conditions to evenly divide an image density among the usable image forming units.

### INCORPORATION BY REFERENCE

This application is based upon, and claims the benefit of priority from, corresponding Japanese Patent Application No. 2020-027940 filed in the Japan Patent Office on Feb. 21, 2020, the entire contents of which are incorporated herein by reference.

### BACKGROUND

### Field of the Invention

The present disclosure relates to an image forming apparatus such as a copying machine, a printer, a facsimile machine, and a multifunction device thereof provided with an image carrier, and particularly relates to an image forming apparatus that performs image formation by filling a plurality of developing devices with toner of a same color and a same type.

### Description of Related Art

In a typical image forming apparatus using an electrophotographic process, an image forming process is performed in which an electrostatic latent image is formed by irradiating an image carrier such as a photoconductor drum that is uniformly charged by a charging device with laser light from an exposure device, after toner is adhered to the electrostatic latent image by the developing device to form a toner image, the toner image is transferred onto paper (recording medium), and a fixing process is performed.

In such an image forming apparatus, generally, a developing device that develops black toner is mounted in an image forming apparatus for forming a monochromatic image, and developing devices that develop toners of a plurality of colors (for example, yellow, magenta, cyan, and black) are mounted in an image forming apparatus for forming a color image.

### SUMMARY

A first configuration according to the present disclosure is directed to an image forming apparatus including a plurality of image forming units, a developing voltage power supply, a current detection unit, and a control unit. The image forming units each includes an image carrier having a photosensitive layer formed on a surface thereof, and a developing device including a developer carrier that is disposed to face the image carrier and carries a developer containing toner, and configured to form an image by adhering the toner to an electrostatic latent image formed on the image carrier, and forms an image by superimposing a toner image of a same color. The plurality of image forming units use the developer containing the toner of a same color and a same type, and substantially same development conditions are set to evenly divide an image density among the image forming units. The developing voltage power supply applies, to the developer carrier, a developing voltage acquired by superimposing an AC voltage on a DC voltage. The current detection unit detects a DC component of developing current that flows when the developing voltage is applied to the developer carrier. The control unit controls the image forming units and the developing voltage power supply. The control unit detects whether there is an anomaly in each of the image forming units, based on at least one of white background portion current I1 being a DC component of developing current flowing through a non-exposed portion of the image carrier detected by the current detection unit during image formation, and image portion current I2 being a DC component of developing current flowing through an exposed portion of the image carrier. When an anomaly is detected in any of the image forming units, the control unit inhibits use of the image forming unit, and resets the development conditions to evenly divide the image density among the usable image forming units.

### BRIEF DESCRIPTION OF THE DRAWINGS

FIG. 1 is a side sectional view showing an internal configuration of an image forming apparatus 100 according to one embodiment of the present disclosure;

FIG. 2 is a side sectional view of a developing device 3a mounted in the image forming apparatus 100;

FIG. 3 is a diagram showing a configuration and a control path of an image forming unit Pa; and

FIG. 4 is a flowchart showing an example of anomaly detection control of image forming units Pa to Pd in the image forming apparatus 100 according to the present embodiment.

### DETAILED DESCRIPTION

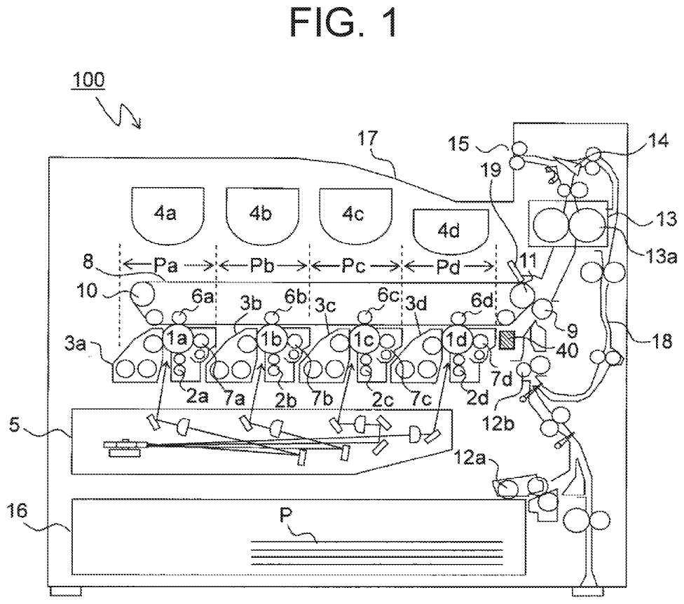

In the following, an embodiment according to the present disclosure is described with reference to the drawings. FIG. 1 is a cross-sectional view showing an internal structure of an image forming apparatus 100 according to one embodiment of the present disclosure. In a main body of the image forming apparatus 100 (herein, a monochromatic printer), four image forming units Pa, Pb, Pc and Pd are disposed in order from an upstream side (left side in FIG. 1) in a transport direction. These image forming units Pa to Pd are provided in association with an image of a same color (black), and a black image is sequentially formed by each step of charging, exposure, development, and transfer.

Photoconductor drums (image carriers) 1a, 1b, 1c and 1d that carry visible images (toner images) of a same color are disposed in these image forming units Pa to Pd, and an intermediary transfer belt (intermediate transfer body) 8 that rotates counterclockwise in FIG. 1 by a belt drive motor (not shown) is provided adjacent to the image forming units Pa to Pd. The toner images formed on the photoconductor drums 1a to 1d are sequentially and primarily transferred and superimposed onto the intermediary transfer belt 8 that moves in contact with each of the photoconductor drums 1a to 1d. Thereafter, the toner images that are primarily transferred onto the intermediary transfer belt 8 are secondarily transferred onto transfer paper P as one example of a recording medium by a secondary transfer roller 9. Further, the transfer paper P on which the toner images are secondarily transferred is discharged from the main body of the image forming apparatus 100 after the toner images are fixed in a fixing unit 13. An image forming process for the photoconductor drums 1a to 1d is performed while rotating the photoconductor drums 1a to 1d clockwise in FIG. 1.

Transfer paper P on which toner images are secondarily transferred is accommodated in a paper cassette 16, which is disposed in a lower part of the main body of the image forming apparatus 100, and is transported to a nip portion between the secondary transfer roller 9 and a driving roller 11 of the intermediary transfer belt 8 via a paper feed roller 12a and a registration roller pair 12b. A sheet made of dielectric resin is used for the intermediary transfer belt 8, and a seamless belt is mainly used. Further, a blade-shaped belt cleaner 19 for removing toner and the like remaining on a surface of the intermediary transfer belt 8 is disposed on a downstream side of the secondary transfer roller 9.

Next, the image forming units Pa to Pd are described. Around and under the rotatably disposed photoconductor drums 1a to 1d, there are provided charging devices 2a, 2b, 2c, and 2d that electrostatically charge the photoconductor drums 1a to 1d, an exposure device 5 that exposes the photoconductor drums 1a to 1d to light of image information, developing devices 3a, 3b, 3c, and 3d that form toner images on the photoconductor drums 1a to 1d, and cleaning devices 7a, 7b, 7c, and 7d that remove a developer (toner) remaining on the photoconductor drums 1a to 1d.

When image data are input from a host device such as a personal computer, first, surfaces of the photoconductor drums 1a to 1d are uniformly charged by the charging devices 2a to 2d. Next, the exposure device 5 irradiates light according to the image data to form an electrostatic latent image according to the image data on the photoconductor drums 1a to 1d. Each of the developing devices 3a to 3d is filled with a specific amount of a two-component developer containing black toner. When a ratio of toner in the two-component developer filled in each of the developing devices 3a to 3d falls below a prescribed value by formation of a toner image to be described later, toner is replenished from toner containers 4a to 4d to the developing devices 3a to 3d. The toner in the developer is supplied onto the photoconductor drums 1a to 1d by the developing devices 3a to 3d, and is electrostatically adhered, whereby a toner image according to the electrostatic latent image formed by exposure from the exposure device 5 is formed.

Then, an electric field is applied between primary transfer rollers 6a to 6d and the photoconductor drums 1a to 1d by the primary transfer rollers 6a to 6d at a specific transfer voltage, and black toner images on the photoconductor drums 1a to 1d are primarily transferred onto the intermediary transfer belt 8. These images are formed with a specific positional relationship that is determined in advance. Thereafter, in preparation for subsequent formation of a new electrostatic latent image, toner and the like remaining on the surfaces of the photoconductor drums 1a to 1d after the primary transfer are removed by the cleaning devices 7a to 7d.

The intermediary transfer belt 8 is stretched between a driven roller 10 on the upstream side, and the driving roller 11 on the downstream side. When the intermediary transfer belt 8 starts to rotate counterclockwise as the driving roller 11 rotates by the belt drive motor (not shown), transfer paper P is transported at a specific timing from a registration roller pair 12b to a nip portion (secondary transfer nip portion) between the driving roller 11 and the secondary transfer roller 9, which is provided adjacent to the driving roller 11, and toner images on the intermediary transfer belt 8 are secondarily transferred onto the transfer paper P. The transfer paper P on which the toner images are secondarily transferred is transported to the fixing unit 13.

The transfer paper P transported to the fixing unit 13 is heated and pressurized by a fixing roller pair 13a to fix the toner images on a surface of the transfer paper P, and a specific monochromatic image is formed. The transfer paper P on which the monochromatic image is formed has its transport direction determined by branching portions 14 branched in a plurality of directions, and is discharged to a discharge tray 17 by a discharge roller pair 15 as it is (or after the transfer paper P is sent to a double-sided transport path 18, and an image is formed on both surfaces thereof).

Further, an image density sensor 40 is disposed on the downstream side of the image forming unit 1d and at a position facing the intermediary transfer belt 8. As the image density sensor 40, an optical sensor including a light emitting element composed of an LED or the like, and a light receiving element composed of a photodiode or the like is generally used. In measuring an amount of toner adhering to the intermediary transfer belt 8, when measurement light is irradiated from the light emitting element to each of reference images formed on the intermediary transfer belt 8, the measurement light is incident to the light receiving element as light reflected by the toner, and light reflected on the belt surface.

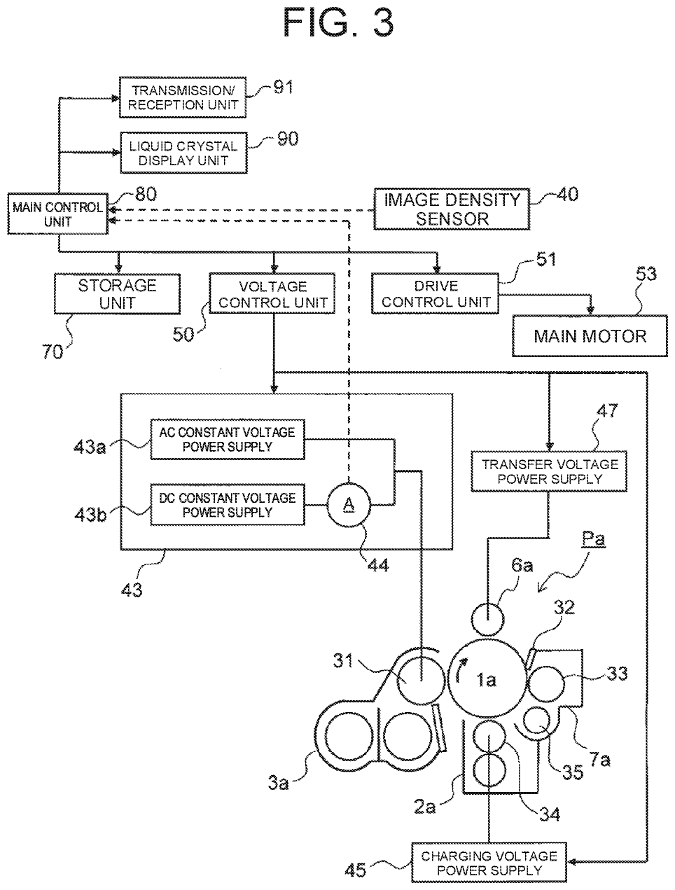

The reflected light from the toner and the belt surface includes specularly reflected light and diffusely reflected light. The specularly reflected light and the diffusely reflected light are separated by a polarization separation prism, and then incident on individual light receiving elements. Each of the light receiving elements photoelectrically converts the received specularly reflected light and diffusely reflected light, and outputs an output signal to a main control unit 80 (see FIG. 3). Then, the toner amount is detected from a characteristic change of the output signals of the specularly reflected light and the diffusely reflected light, and density correction (calibration) is performed by adjusting a characteristic value and the like of a developing voltage in comparison with a reference density that is determined in advance.

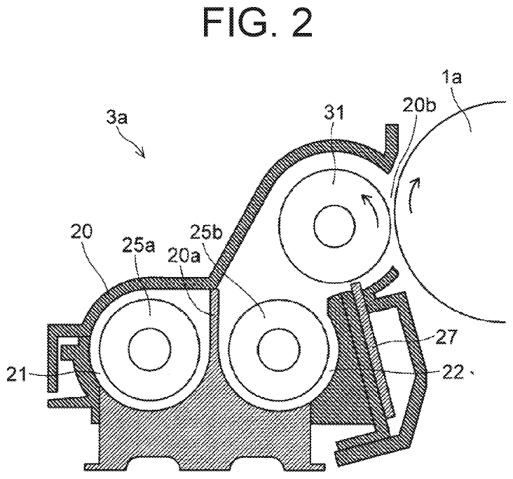

FIG. 2 is a side sectional view of the developing device 3a mounted in the image forming apparatus 100. In the following description, the developing device 3a disposed in the image forming unit Pa in FIG. 1 is exemplified. However, since configurations of the developing devices 3b to 3d disposed in the image forming units Pb to Pd are basically similar to the above, description thereof is omitted.

As shown in FIG. 2, the developing device 3a includes a developing container 20 in which a two-component developer (hereinafter, simply referred to as a developer) containing magnetic carrier and toner is stored, and the developing container 20 is divided into a stirring transport chamber 21 and a supply transport chamber 22 by a partition wall 20a. A stirring transport screw 25a and a supply transport screw 25b for mixing toner to be supplied from the toner container 4a (see FIG. 1) with magnetic carrier to stir and charge the toner are respectively and rotatably disposed in the stirring transport chamber 21 and the supply transport chamber 22. In the present embodiment, a two-component developer composed of positively charged toner having an average particle diameter of 6.8 μm, and ferrite/resin coated carrier having an average particle diameter of 35 μm is used, and a toner density (weight ratio of toner to magnetic carrier) is set to 6%.

Then, the developer is transported in the axial direction (direction perpendicular to the plane of FIG. 2) while being stirred by the stirring transport screw 25a and the supply transport screw 25b, and circulates between the stirring transport chamber 21 and the supply transport chamber 22 via an unillustrated developer passage path, which is formed at both ends of the partition wall 20a. Specifically, a circulation path for the developer is formed within the developing container 20 by the stirring transport chamber 21, the supply transport chamber 22, and the developer passage path.

The developing container 20 extends obliquely upward to the right in FIG. 2, and a developing roller 31 is disposed obliquely upward to the right of the supply transport screw 25b within the developing container 20. Then, a part of an outer peripheral surface of the developing roller 31 is exposed through an opening 20b of the developing container 20, and faces the photoconductor drum 1a. The developing roller 31 rotates counterclockwise in FIG. 2. In the present embodiment, a peripheral speed ratio of the developing roller 31 to the photoconductor drum 1a is set to 1.8 (trail rotation at the opposite position), and a distance between the developing roller 31 and the photoconductor drums 1a to 1d is set to 0.30 mm.

The developing roller 31 is constituted of a cylindrical developing sleeve that rotates counterclockwise in FIG. 2, and a magnet (not shown) having a plurality of magnetic poles fixed within the developing sleeve. Although a developing sleeve having a knurled surface is used herein, it is also possible to use a developing sleeve having a large number of concave shapes (dimples) on a surface thereof, a developing sleeve having a blasted surface, and a developing sleeve having a blasted surface or a plated surface in addition to a knurled shape or a concave shape. In the present embodiment, a developing roller 31 having a diameter of 20 mm in which eighty rows of recesses are formed in a circumferential direction by knurling and blasting is used, and a developer transport amount by the developing roller 31 is set to 250 to 300 g/m².

Further, a regulation blade 27 is attached to the developing container 20 along the longitudinal direction of the developing roller 31 (perpendicular to the plane of FIG. 2). A slight clearance (gap) is formed between a tip of the regulation blade 27 and a surface of the developing roller 31. In the present embodiment, a magnetic blade made of stainless steel (SUS430) is used as the regulation blade 27.

A developing voltage including a DC voltage Vdc and an AC voltage Vac is applied to the developing roller 31 by a developing voltage power supply 43 (see FIG. 3). As the development voltage, for example, a voltage acquired by superimposing an AC voltage Vac of a rectangular wave having a frequency of 5 kHz, Vpp=1100 V, and Duty=50% on a DC voltage Vdc is used.

FIG. 3 is a diagram showing a configuration and a control path of the image forming unit Pa including the developing device 3a. In the following description, the configuration and the control path of the image forming unit Pa are described. However, since configurations and control paths of the image forming units Pb to Pd are similar to the above, description thereof is omitted.

The developing roller 31 is connected to the developing voltage power supply 43 that generates a vibration voltage in which a DC voltage and an AC voltage are superimposed. The developing voltage power supply 43 includes an AC constant voltage power supply 43a and a DC constant voltage power supply 43b. The AC constant voltage power supply 43a outputs a sinusoidal AC voltage generated from a low-voltage DC voltage, which is pulse-modulated by using a step-up transformer (not shown). The DC constant voltage power supply 43b outputs a DC voltage acquired by rectifying a sinusoidal AC voltage generated from a low-voltage DC voltage, which is pulse-modulated by using a step-up transformer.

The developing voltage power supply 43 outputs a developing voltage acquired by superimposing an AC voltage on a DC voltage from the AC constant voltage power supply 43a and the DC constant voltage power supply 43b during image formation. A current detection unit 44 detects a value of DC current flowing between the developing roller 31 and the photoconductor drum 1a.

A charging voltage power supply 45 applies, to a charging roller 34 of the charging device 2a, a charging voltage in which an AC voltage is superimposed on a DC voltage. The configuration of the charging voltage power supply 45 is similar to that of the developing voltage power supply 43. A transfer voltage power supply 47 applies a primary transfer voltage and a secondary transfer voltage to the primary transfer rollers 6a to 6d and the secondary transfer roller 9 (see FIG. 1), respectively.

The cleaning device 7a includes a cleaning blade 32 that removes residual toner on the surface of the photoconductor drum 1a, a rubbing roller 33 that removes residual toner on the surface of the photoconductor drum 1a, and rubbing and polishing the surface of the photoconductor drum 1a, and a transport spiral 35 that discharges residual toner removed from the photoconductor drum 1a by the cleaning blade 32 and the rubbing roller 33 to the outside of the cleaning device 7a.

Next, a control system of the image forming apparatus 100 is described with reference to FIG. 3. The image forming apparatus 100 is provided with the main control unit 80 constituted of a CPU and the like. The main control unit 80 is connected to a storage unit 70 including a ROM, a RAM, and the like. The main control unit 80 controls, based on a control program and control data stored in the storage unit 70, each unit of the image forming apparatus 100 (charging devices 2a to 2d, developing devices 3a to 3d, exposure device 5, primary transfer rollers 6a to 6d, cleaning devices 7a to 7d, secondary transfer roller 9, fixing unit 13, developing voltage power supply 43, current detection unit 44, charging voltage power supply 45, transfer voltage power supply 47, voltage control unit 50, drive control unit 51, and the like).

The voltage control unit 50 controls the developing voltage power supply 43 that applies a developing voltage to the developing roller 31, the charging voltage power supply 45 that applies a charging voltage to the charging roller 34, and the transfer voltage power supply 47 that applies a transfer voltage to the primary transfer rollers 6a to 6d and the secondary transfer roller 9. The drive control unit 51 controls a main motor 53 that rotationally drives the photoconductor drums 1a to 1d. The voltage control unit 50 and the drive control unit 51 may be constituted of a control program stored in the storage unit 70.

A liquid crystal display unit 90 and a transmission/reception unit 91 are connected to the main control unit 80. The liquid crystal display unit 90 functions as a touch panel for the user to perform various settings of the image forming apparatus 100, and displays a state of the image forming apparatus 100, an image forming status, the number of prints, and the like. The transmission/reception unit 91 communicates with the outside by using a telephone line or an Internet line.

The image forming apparatus 100 according to the present embodiment is provided with four developing devices 3a to 3d filled with toner of a same color, and developing is performed by distributing an amount of toner necessary for forming an image at a target density for each of the developing devices 3a to 3d. Specifically, when only A is necessary as a toner development amount for forming an image at a target density, and developing is performed by using the four developing devices 3a to 3d, developing is performed by distributing the toner development amount by A/4 for each of the developing devices 3a to 3d.

A developing method including a plurality of (herein, four) developing devices 3a to 3d filled with toner of a same color and a same type is advantageous when a frequency with which an image having a high printing rate is continued is high. When the printing rate is high, a difference in the image density is likely to occur in the axial direction of the developing roller 31. As a result, it becomes difficult to reproduce uniformity with only one developing device. In view of the above, by superimposing a halftone image by the plurality of developing devices 3a to 3d, uniformity can be reproduced. Further, in some cases, by setting a transport direction of a developer in stirring sections of two of the four developing devices 3a to 3d (for example, the developing devices 3b and 3d) in the opposite direction, image uniformity in the axial direction of the developing roller 31 can be further improved.

As described above, in a method of forming an image by superimposing a toner image of a same color a plurality of times, when an anomaly occurs in any of the developing devices 3a to 3d, it is preferable to form an image by stopping use of the image forming units Pa to Pd including the anomalous developing devices 3a to 3d, and using the other image forming units Pa to Pd. In addition, the anomaly may be recovered by causing the anomalous developing devices 3a to 3d to perform an aging operation or a forcible ejection operation of toner while the anomalous developing devices 3a to 3d are kept in a stopped state or are not in use. In this case, it is necessary to resume the image forming units Pa to Pd in an unused state.

In order to determine stopping or resuming the image forming units Pa to Pd as described above, it is necessary to detect in which one of the image forming units Pa to Pd, an anomaly has occurred, or an anomaly has been resolved. However, when image formation is performed by using the image forming units Pa to Pd including the developing devices 3a to 3d filled with toner of a same color, occurrence of an anomaly or recovery of the image forming units Pa to Pd cannot be easily detected.

In view of the above, in the image forming apparatus 100 according to the present embodiment, a DC component of developing current flowing between the developing rollers 31 of the developing devices 3a to 3d and the photoconductor drums 1a to 1d during image formation is measured, and anomalous image forming units Pa to Pd are detected, based on the measured DC component of developing current. In the following, a method of detecting anomalous image forming units Pa to Pd is described.

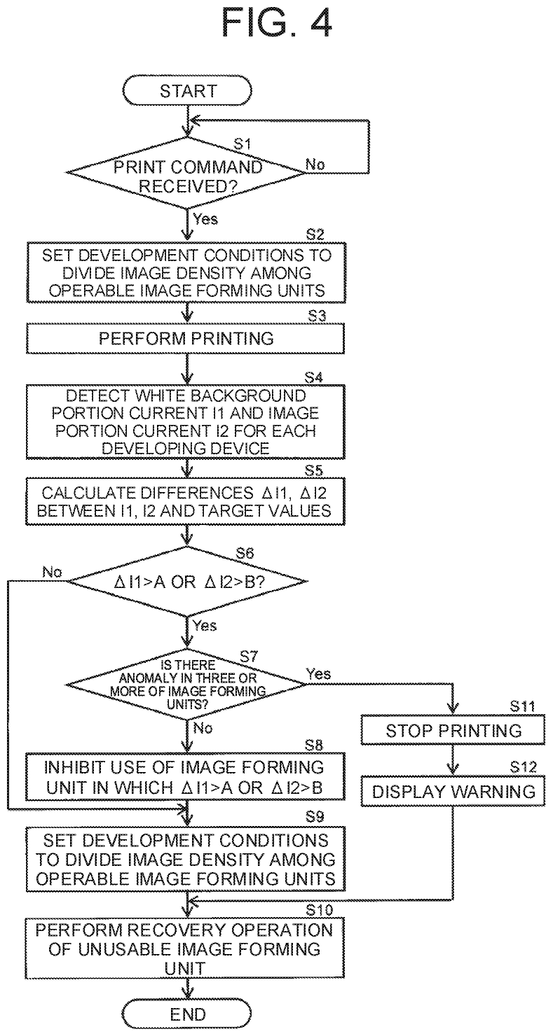

FIG. 4 is a flowchart showing an example of anomaly detection control of the image forming units Pa to Pd in the image forming apparatus 100 according to the present disclosure. An anomaly detection procedure of the image forming units Pa to Pd is described in detail along the steps in FIG. 4 with reference to FIGS. 1 to 3 as necessary.

First, the main control unit 80 determines whether a print command is received (step S1). When the print command is received (Yes in step S1), development conditions are set to divide an image density among the operable image forming units Pa to Pd (step S2). Since all of the four image forming units Pa to Pd are normal at an initial stage of use of the image forming apparatus 100, development conditions (development potential difference Vdc−VL) of each of the developing devices 3a to 3d are set to divide the image density into four equal parts.

For example, when a target density (ID; image density)=0.8, the development potential difference Vdc−VL necessary for dividing the target density into four equal parts (ID=0.2) is set. In the present embodiment, when all of the four image forming units Pa to Pd are used, a DC voltage Vdc=250V of a developing voltage and a surface potential V0=350V are set. Then, printing is performed under the set development conditions (step S3).

Next, the main control unit 80 detects a DC component (white background portion current I1) of developing current flowing in a white background portion (non-exposed portion), and a DC component (image portion current I2) of developing current flowing in an image portion (exposed portion) with the current detection unit 44 for each of the developing devices 3a to 3d (step S4). The developing current is current flowing between the photoconductor drums 1a to 1d and the developing roller 31 by movement of toner, and is about 2 to 5 ρA.

Since the image density (toner development amount) is equally divided among the developing devices 3a to 3d, developing current flowing by toner movement is also substantially the same among the developing devices 3a to 3d. In a white background portion (a margin before and after an image and a portion between sheets of paper), toner present in a developing region moves from the photoconductor drums 1a to 1d side to the developing roller 31 side. At this occasion, if there is a defect in a surface potential or exposure, the white background portion current I1 changes. In an image portion, toner moves from the developing roller 31 to the photoconductor drums 1a to 1d side. At this occasion, if there is a defect in an electrostatic latent image or the developing devices 3a to 3d, the image portion current I2 changes.

Therefore, when the white background portion current I1 and the image portion current I2 of the developing devices 3a to 3d are measured, if there is a large deviation, it is possible to predict that a defect occurs in the image forming units Pa to Pd including the developing devices 3a to 3d. For example, when the image portion current I2 is excessively high, a black streak or the like may be generated in an image, and when the image portion current I2 is excessively low, a white streak or the like may be generated in an image.

Next, the main control unit 80 calculates a difference ΔI1 between the white background portion current I1 and a target value, and a difference ΔI2 between the image portion current I2 and a target value (step S5). As the target values of the white background portion current I1 and the image portion current I2, it is possible to use current values that are stored in advance in the storage unit 70 and are predicted from a relationship between a printing rate and developing current. The relationship between the printing rate and the developing current is shown in FIG. 5.

Alternatively, a reference pattern having a constant printing rate may be developed each time a specific number of prints is reached, and white background portion current and image portion current flowing during development may be measured and stored in the storage unit 70. Thus, it is possible to acquire a time change of white background portion current and image portion current. Then, it is possible to convert predicted values of the white background portion current and the image portion current that are predicted from the time change into a printing rate of an image to be actually formed, and set the printing rate as a target value.

Next, the main control unit 80 determines whether ΔI1 and ΔI2 calculated in step S4 are ΔI1>A or ΔI2>B (step S6). A and B are upper limit values of ΔI1 and ΔI2, respectively. A and B can be set to, for example, 30% of the target values. When either one of the white background portion current I1 and the image portion current I2 is deviated from the target value by 30% or more, specifically, ΔI1>A or ΔI2>B, the main control unit 80 determines that there is an anomaly in any of the image forming units Pa to Pd in which ΔI1>A or ΔI2>B.

When ΔI1>A or ΔI2>B in any of the image forming units Pa to Pd (Yes in step S6), the main control unit 80 determines whether there is an anomaly in three or more of the image forming units Pa to Pd (step S7). When there is an anomaly in two or less of the image forming units Pa to Pd (No in step S7), the main control unit 80 inhibits use of the image forming units Pa to Pd in which ΔI1>A or ΔI2>B (step S8).

Next, the main control unit 80 sets development conditions to divide an image density among the image forming units Pa to Pd that are operable at a present time (step S9). For example, when the target density ID=0.8, and ΔI1>A or ΔI2>B in the developing device 3a, the main control unit 80 inhibits use of the image forming unit Pa, and changes each of the target densities to ID=0.27 to divide the image density into three equal parts among the remaining image forming units Pb to Pd. Then, the main control unit 80 resets the development conditions of the developing devices 3b to 3d. The resetting method includes a method of changing the development potential difference Vdc−VL required to set ID=0.27 by calculation, and a method of performing calibration to reset Vdc−VL. In the present embodiment, when three of the developing devices 3a to 3d are used, a DC voltage Vdc=300V of a developing voltage, and a surface potential V0=400V are set.

On the other hand, in step S6, when ΔI1<A and ΔI2<B are satisfied in all the image forming units Pa to Pd (No in step S6), the development conditions are set to divide the image density into four equal parts among the operable four image forming units Pa to Pd (step S9).

For example, when the development conditions of the image forming units Pa to Pd are set to divide the image density into four equal parts in advance in step S2, it is not necessary to reset the development conditions. When it is determined that there is an anomaly in the image forming unit Pa in a previous printing operation, and the development conditions of each of the image forming units Pb to Pd are set to divide the image density into three equal parts, the development potential difference Vdc−VL, which is necessary for dividing the image density into four equal parts among the four image forming units Pa to Pd including the image forming unit Pa that becomes usable by a recovery operation, is changed by calculation, or calibration is performed by changing the target density to reset Vdc−VL.

Thereafter, when there are unusable image forming units Pa to Pd, the main control unit 80 performs a recovery operation of the image forming units Pa to Pd (step S10). For example, when the image forming unit Pa is unusable, it is presumed that the white background portion current I1 or the image portion current I2 of the developing device 3a is greater (or smaller) than that of the other developing devices 3b to 3d for some reason. Depending on a reason of change in the white background portion current I1 or the image portion current I2, it is possible to classify causes into those that are resolved by performing a specific recovery operation, and those that cannot be resolved even when a recovery operation is performed.

In view of the above, by performing a recovery operation according to a change in the white background portion current I1 or the image portion current I2, and detecting the white background portion current I1 and the image portion current I2 during a next image forming operation, it is possible to determine whether the image forming unit Pa that is determined to be anomalous is recovered.

As a specific example of the recovery operation, when the white background portion current I1 is lower (or higher) than a certain value, specifically, when the white background portion current I1 is out of a specific range, the surface potential of the photoconductor drum 1a may be lowered or raised. In view of the above, a refreshing (polishing) operation of the photoconductor drum 1a is performed.

On the other hand, when the image portion current I2 is lower (or higher) than a certain value, specifically, when the image portion current I2 is out of a specific range, a toner charge amount within the developing device 3a may be increased or decreased. In view of the above, an electrostatic latent image pattern (solid pattern) is formed on the photoconductor drums 1a to 1d, and a developing voltage is applied to the developing roller 31 to move (forcibly eject) toner on the developing roller 31 onto the photoconductor drums 1a to 1d. Thereafter, new toner is replenished from the toner containers 4a to 4d.

Further, when the toner charge amount is increased, it is also effective to use a method in which the developing devices 3a to 3d are kept stationary for a certain period of time to stabilize the toner charge amount. When the toner charge amount is decreased, it is also effective to use a method of lengthening the aging (stirring) time of a developer within the developing devices 3a to 3d. These recovery operations can be selected according to properties of toner for use.

Further, as a cause of the white background portion current I1 or the image portion current I2 being out of a specific range, a transport failure of a developer due to clogging of foreign matter in a gap (developer regulating portion) between the developing roller 31 and the regulation blade 27 is also conceived. In this case, a method of removing foreign matter by rotating the developing roller 31 in a reverse direction is also effective.

Then, when ΔI1<A and ΔI2<B are satisfied by the recovery operation, the development conditions are reset again together with the other image forming units Pb to Pd. When recovery is not possible even after the recovery operation is performed, the liquid crystal display unit 90 is notified to urge replacement of the photoconductor drum 1a, the developing device 3a, and the like, since it is necessary to replace the photoconductor drum 1a, the developing device 3a, and the like. Further, when it is determined that there is an anomaly in the image forming unit Pa, the photoconductor drum 1a and the developing device 3a may be replaced without performing the recovery operation.

Further, when there is an anomaly in three or more of the image forming units Pa to Pd (for example, image forming units Pa to Pc) in step S7 (Yes in step S7), an operable image forming unit among the image forming units Pa to Pd is only one (image forming unit Pd). In this case, since image quality cannot be guaranteed, printing is stopped (step S11). Then, a warning is displayed on the liquid crystal display unit 90 (step S12), a recovery operation of the image forming units Pa to Pc that are determined to be anomalous is performed (step S10), and the process is finished.

According to the control example shown in FIG. 4, in the image forming apparatus 100 in which the developing devices 3a to 3d are filled with toner of a same color and a same type to form an image, it is possible to easily and accurately detect an anomaly in the image forming units Pa to Pd by using the white background portion current I1 and the image portion current I2 flowing during image formation. Further, since it is not necessary to form a reference image for current detection when an image is not formed, it is possible to suppress consumption of toner during a period other than printing.

Then, by determining whether the image forming units Pa to Pd are usable based on a detection result, and setting development conditions of the usable image forming units Pa to Pd, it is possible to advantageously suppress image defects such as development ghost, image fog, and a transfer failure resulting from a change in the white background portion current I1 and the image portion current I2.

In addition, by performing a recovery operation for the image forming units Pa to Pd, which are determined to be unusable, it is possible to restore the image forming units Pa to Pd to a usable state. Thus, there is no likelihood that the recoverable photoconductor drums 1a to 1d and developing devices 3a to 3d may be replaced, and it is also possible to reduce the running cost of the image forming apparatus 100.

In the control example shown in FIG. 4, the recovery operation of the image forming units Pa to Pd, which are unusable, is performed after printing is finished. However, a timing of performing the recovery operation is not limited to the above. For example, the recovery operation may be performed between sheets of paper being printed. Alternatively, a dedicated recovery mode may be provided, and the recovery mode may be performed at any timing by input from the liquid crystal display unit 90 or a personal computer.

Further, in the above control example, the recovery operation is performed for the image forming units Pa to Pd in which ΔI1>A or ΔI2>B. However, as far as the white background portion current I1 or the image portion current I2 is higher (or lower) than a certain level, even when ΔI1<A and ΔI2<B are satisfied, the recovery operation may be performed. For example, when ΔI1 is A′ (20% of the target value) or more, and ΔI2 is B′ (20% of the target value) or more, a forcible ejection operation may be performed between sheets of paper being printed or after printing is finished, or a recovery operation such as lengthening the aging (stirring) time may be performed.

Further, determination as to whether the image forming units Pa to Pd that are unusable are recovered may be performed during normal image formation. However, by forming a reference image for determination between sheets of paper, it is possible to determine recovery of the image forming units Pa to Pd, and perform resetting of the development conditions after recovery without affecting a normal printing operation.

Other features of the present disclosure are not limited to the above embodiment, and various changes are available without departing from the spirit of the present disclosure. For example, in the above embodiment, as the target values of the white background portion current I1 and the image portion current I2, current values to be predicted from a relationship between a printing rate and developing current, which is stored in advance in the storage unit 70, are used. However, for example, it is also possible to use, as the target values, calculated average values of the white background portion current I1 and the image portion current I2 of each of the developing devices 3a to 3d.

However, when determination is made based on a difference with respect to average values of the white background portion current I1 and the image portion current I2, if an anomaly of developing current occurs in two or more of the image forming units Pa to Pd at the same time, a normal value may be deviated from the average values. In view of the above, it is preferable to determine whether there is an anomaly in the image forming units Pa to Pd by setting, as a target value, a current value to be predicted from a relationship between a printing rate and developing current as described above in the embodiment.

Further, in the above embodiment, an anomaly in the image forming units Pa to Pd is detected by using both of the white background portion current I1 and the image portion current I2. However, an anomaly in the image forming units Pa to Pd may be detected by using only one of the white background portion current I1 and the image portion current I2.

Further, in the above embodiment, the image forming apparatus 100 has been described by taking, as an example, a monochromatic printer in which the developing devices 3a to 3d are filled with black toner as shown in FIG. 1. However, the image forming apparatus 100 is not limited to a monochromatic printer and a monochromatic copying machine, and may be a color copying machine or a color printer provided with a plurality of developing devices for each color.

The present disclosure is applicable to an image forming apparatus that forms an image by filling a plurality of developing devices with toner of a same color and a same type. By using the present disclosure, it is possible to provide an image forming apparatus capable of easily and accurately detecting an image forming unit in which an anomaly has occurred, and advantageously suppressing occurrence of image defects.

What is claimed is:

1. An image forming apparatus comprising:
a plurality of image forming units each of which includes
an image carrier having a photosensitive layer formed on a surface thereof, and
a developing device including a developer carrier that is disposed to face the image carrier and carries a developer containing toner, and configured to form a toner image by adhering the toner to an electrostatic latent image formed on the image carrier, and forms an image by superimposing a toner image of a same color;
a developing voltage power supply that applies, to the developer carrier, a developing voltage acquired by superimposing an AC voltage on a DC voltage;
a current detection unit that detects a DC component of developing current that flows when the developing voltage is applied to the developer carrier; and
a control unit that controls the image forming units and the developing voltage power supply, wherein
the plurality of image forming units use the developer containing the toner of a same color and a same type, and substantially same development conditions are set to evenly divide an image density among the image forming units,
the control unit detects whether there is an anomaly in each of the image forming units, based on at least one of white background portion current I1 being a DC component of developing current flowing through a non-exposed portion of the image carrier detected by the current detection unit during image formation, and image portion current I2 being a DC component of developing current flowing through an exposed portion of the image carrier, and
when an anomaly is detected in any of the image forming units, the control unit inhibits use of the image forming unit, and resets the development conditions to evenly divide the image density among the usable image forming units.

2. The image forming apparatus according to claim 1, wherein
the control unit determines that there is an anomaly in the image forming unit, when at least one of a difference ΔI1 between the white background portion current I1 and a target value, and a difference ΔI2 between the image portion current I2 and a target value is equal to or less than a lower limit value, or is equal to or greater an upper limit value.

3. The image forming apparatus according to claim 1, wherein
the control unit determines that there is an anomaly in the image forming unit, when at least one of the white background portion current I1 and the image portion current I2 is deviated from an average value of the white background portion current I1 or the image portion current I2 of all the image forming units by a specific value or more.

4. The image forming apparatus according to claim 1, wherein
the control unit performs a recovery operation of recovering the image forming unit in which an anomaly is detected.

5. The image forming apparatus according to claim 4, wherein
the control unit performs a refreshing operation of polishing a photosensitive layer of the image carrier as the recovery operation, when the white background portion current I1 is out of a specific range.

6. The image forming apparatus according to claim 4, wherein
the control unit performs a forcible ejection operation of ejecting the toner within the developing device onto the image carrier as the recovery operation, when the image portion current I2 is out of a specific range.

7. The image forming apparatus according to claim 4, wherein
the control unit detects again at least one of the white background portion current I1 and the image portion current I2 of the image forming unit in which an anomaly is detected, and resets the development conditions to evenly divide the image density among the usable image forming units including the image forming unit, when the image forming unit is recovered by the recovery operation.

8. The image forming apparatus according to claim 4, further comprising a notification device that notifies a state of the image forming unit, wherein
the control unit causes the notification unit to notify to urge replacement of the image carrier or the developing device within the image forming unit, when the image forming unit is not recovered after the recovery operation is performed.

9. The image forming apparatus according to claim 1, further comprising three or more of the image forming units, wherein
the control unit stops an image forming operation, when the number of usable image forming units is one or less.
